(19) United States
(12) Patent Application Publication
(10) Pub. No.: US 2026/0296558 A1
(43) Pub. Date: Oct. 1, 2026

(54) GLASS PANE ARRANGEMENT FOR A VEHICLE, AND VEHICLE

(71) Applicant: Webasto SE, Stockdorf (DE)

(72) Inventor: Matthias BAUMANN, Stockdorf (DE)

(21) Appl. No.: 19/480,737

(22) PCT Filed: Mar. 4, 2024
(86) PCT No.: PCT/EP2024/055566

§ 371 Date: Oct. 31, 2025

(30) Foreign Application Priority Data
May 4, 2023 (DE) 10 2023 111 600.2

(51) Int. Cl. B62D 25/06; B60Q 3/208; B60Q 3/64; B62D 29/04

(52) U.S. Cl. CPC B62D 25/06; B60Q 3/208; B60Q 3/64; B62D 29/043

(57) ABSTRACT

A glass pane arrangement for a vehicle having a planar light-guiding glass pane, a functional element which is fixed on a main side of the light-guiding glass pane by means of an adhesive bond, a reflection layer which is arranged between the light-guiding glass pane and the functional element in order to reflect light towards the light-guiding glass pane.

### CROSS-REFERENCE TO RELATED APPLICATIONS

This application is a U.S. national phase application filed under 35 U.S.C. § 371 of International Application No. PCT/EP2024/055566, filed on Mar. 4, 2024, published under WO 2024/227529 A1 on Nov. 7, 2024, designating the United States, which claims priority from German Patent Application Number 10 2023 111 600.2, filed on May 4, 2023, which are hereby incorporated herein by reference in their entirety.

### FIELD

A glass pane arrangement for a vehicle is specified. Moreover, a vehicle which comprises such a glass pane arrangement is specified.

### BACKGROUND

Motor vehicles comprise transparent or translucent glass panes at various locations. A composite glass pane for a vehicle is described in EP 3787894 A1. The glass panes can be illuminated.

It is desirable to specify a glass pane arrangement for a vehicle which enables reliable operation and in particular enables undesired decoupling of light from the glass pane to be avoided. Moreover, it is desirable to specify a vehicle having such a glass pane arrangement.

### SUMMARY

This is achieved by the independent claims. Particularly advantageous embodiments are the subject matter of the dependent claims.

According to one embodiment of the invention, a glass pane arrangement for a vehicle comprises:
a plate-shaped light-guiding glass pane,
a functional element, which is fixed by means of an adhesive bond on a main side of the light-guiding glass pane,
a reflection layer, which is arranged between the light-guiding glass pane and the functional element to reflect light in the direction of the light-guiding glass pane.

The plate-shaped light-guiding glass pane comprises, for example, a glass pane and/or a plastic pane. The light-guiding glass pane is in particular transparent or translucent. The light-guiding glass pane is designed to guide the light of a light source along the main side. The light can be decoupled from the light-guiding glass pane. Illumination for the vehicle, in particular illumination for the interior of the vehicle, is therefore implementable by means of the light-guiding glass pane and the light source. For example, the light-guiding glass pane is part of a composite glass pane, which comprises two or more glass panes that are connected to one another.

The light-guiding glass pane is formed, for example, from a single glass pane. Alternatively, the light-guiding glass pane can be constructed from a plurality of layers. For example, the light-guiding glass pane comprises a light-guiding layer which has approximately the same index of refraction as the one adjoining glass pane has. The glass pane and the light-guiding layer jointly guide light along the main side. For example, the light-guiding layer is arranged between the glass pane and the functional element.

The light-guiding glass pane is flatly extended and extends in particular with a main side along an XY plane. The main side faces toward the interior of the vehicle in operation, for example. The main side has a significantly greater extension than a transverse side oriented transversely thereto. In operation, the main side is in particular oriented essentially along the horizontal. The transverse side is oriented essentially along the, or parallel to, the normal to the main side, i.e. essentially along the vertical, thus in particular along a vertical direction Z.

The functional element is, for example, a plastic element. For example, the functional element is designed to couple other elements of the vehicle to the light-guiding glass pane. For example, the functional element provides an interface for the attachment of an interior roof lining. In particular, the functional element is a part of a connection for attaching an interior roof lining of the vehicle to the light-guiding glass pane. For example, the interior roof lining is fastenable to the light-guiding glass pane by means of the functional element by means of an attachment connection and/or clip connection.

According to embodiments, the glass pane arrangement comprises a plurality of functional elements which are arranged spaced apart from one another in or on the main side of the light-guiding glass pane. For example, the area over which the functional element is coupled to the light-guiding glass pane does not extend over the entire length/area of the main side of the light-guiding glass pane, but rather has a significantly smaller extension than the light-guiding glass pane. Analogously or additionally, one or more functional elements can be arranged on the side of the light-guiding glass pane opposite to the main side.

An arrangement of components such as the functional element on the light-guiding glass pane generally results in light decoupling. However, this light decoupling is not always desired. In particular, no light decoupling is to take place at the functional element. The reflection layer is provided for this purpose.

The reflection layer enables the reflection of the light, for example, due to an index of refraction jump. For example, an index of refraction of the reflection layer deviates from an index of refraction of an adjoining layer.

For example, the light-guiding glass pane has an index of refraction of 1.55 or 1.52. An adjoining layer, for example a hot melt adhesive layer adjacent to the light-guiding glass pane, has, for example, an index of refraction of 1.48. This index of refraction jump is sufficient to cause a total reflection at the boundary layer between light-guiding glass pane and adjacent layer. A greater difference of the respective index of refraction is preferably selected between light-guiding glass pane and adjoining layer, wherein preferably an index of refraction for the adjoining layer of less than 1.48 is selected.

In particular, an index of refraction jump between light-guiding glass pane and adjoining layer by more than 0.01 is provided, for example by more than 0.1. A total reflection of light occurs at the reflection layer due to the index of refraction jump, so that the light guided in the light-guiding glass pane does not decouple from the light-guiding layer at the reflection layer.

The reflection layer is formed, for example, from transparent or largely transparent material. Optional layers between reflection layer and light guide are, for example, likewise embodied transparently or substantially transparently.

It is also possible that the reflection layer is alternatively or additionally formed by means of a mirror layer. The reflection layer is made glossy or mirrored, in order to reflect in particular the light guided in the light-guiding glass pane, so that the light guided in the light-guiding glass pane is not decoupled due to the reflection layer but rather continues to be guided reflected in the light-guiding glass pane and therefore remains in the light-guiding glass pane in the area of the functional element. For example, the reflection layer is formed from a metal; for example, the reflection layer comprises aluminum or silver.

The reflection layer enables reliable guiding of the light in the light-guiding glass pane even at the point at which the functional element is attached to the main side by means of the adhesive bond. Absorption and/or spectral splitting of the light caused by absorption or reflection at the adhesive bond and in particular at the functional element is thus avoided or at least reduced. The efficiency of the light guiding in the light-guiding glass pane is therefore increased. The light in particular comprises electromagnetic radiation in the range visible to humans. Moreover, no or minor spectral change of the light guided in the light-guiding glass pane is present in the area of the functional element or the reflection layer. Furthermore, shading due to absorption or decoupling is reduced/avoided.

The reflection layer in particular enables the use of a dark, for example black, functional element without a large amount of light undesirably being absorbed in the area of the functional element. Undesired decoupling at the adhesive bond is also avoidable by means of the reflection layer. Uniform light guiding within the light-guiding glass pane is therefore implementable even with the adhesively bonded functional element. Areas luminescing less strongly behind the functional element and the adhesive bond are avoidable. The reliability and the efficiency of the glass pane arrangement is therefore increased.

According to at least one embodiment, the reflection layer is arranged between the light-guiding glass pane and the adhesive bond. The light is reflected from the reflection layer before it can enter the adhesive bond. The adhesive bond is in particular arranged between the reflection layer and the functional element. In particular, the reflection layer is designed as a mirror layer in this embodiment. For example, the reflection layer is vapor deposited and/or printed on the main side. For example, the reflection layer comprises a metal layer. In particular, the reflection layer is applied directly to the main side of the light-guiding glass pane. Decoupling of the light due to the adhesive bond is therefore reliably avoided.

According to at least one embodiment, the reflection layer is alternatively or additionally arranged between the functional element and the adhesive bond. The adhesive bond is arranged between the light-guiding glass pane and the reflection layer. Light enters the adhesive bond from the light-guiding glass pane, for example, at the adhesive bond and is then reflected at the reflection layer and coupled through the adhesive bond back into the light-guiding glass pane.

For example, the light-guiding glass pane and the adhesive bond have an identical or very similar index of refraction in order to be able to implement the decoupling and coupling of the light between the light-guiding glass pane and the adhesive bond. The reflection layer reduces absorption of the light at the functional element.

The reflection layer is designed in this embodiment in particular as a mirror layer. In particular, a coupling surface of the functional element facing toward the light-guiding glass pane is formed mirrored.

According to at least one embodiment, the adhesive bond comprises an adhesive layer. The reflection layer is formed by means of the adhesive layer. The adhesive layer is formed from an adhesive in order to adhesively bond the functional element to the light-guiding glass pane. The adhesive layer in particular has a first index of refraction. The light-guiding glass pane has a second index of refraction. The first index of refraction is less than the second index of refraction. Therefore, a total reflection occurs at the boundary surface between the adhesive layer and the light-guiding glass pane. In particular, the first index of refraction is less by 0.1 or more than the second index of refraction. For example, the first index of refraction has a value between 1 and 1.45, in particular a value less than 1.35.

According to at least one embodiment, the adhesive bond comprises an adhesive tape. The reflection layer is formed as part of the adhesive tape. For example, the adhesive tape comprises a substrate layer, to which the reflection layer is applied, and an adhesive layer in order to fix the adhesive tape on the light-guiding glass pane. The functional element can be adhesively bonded to the substrate layer. For example, the adhesive tape is formed as a double-sided adhesive tape. It is therefore possible that the substrate layer of the adhesive tape is itself formed having the low index of refraction in order to implement the total reflection.

According to at least one embodiment, a vehicle is specified which comprises a glass pane arrangement according to one of the embodiments described here. The glass pane arrangement closes a roof opening of the vehicle. The glass pane arrangement is therefore designed, for example, as a so-called fixed glass element for the vehicle roof. Interior lighting for the vehicle is implementable by means of the glass pane arrangement in the vehicle roof.

### BRIEF DESCRIPTIONS OF THE DRAWINGS

Further advantages, features, and refinements result from the following examples explained in conjunction with the figures. Identical, equivalent, and identically acting elements can be provided with the same reference signs across the figures.

In the figures:

FIG. 1 shows a schematic illustration of a part of a vehicle according to an exemplary embodiment,

FIGS. 2 to 6 each show schematic illustrations of a glass pane arrangement according to exemplary embodiments.

### DETAILED DESCRIPTION

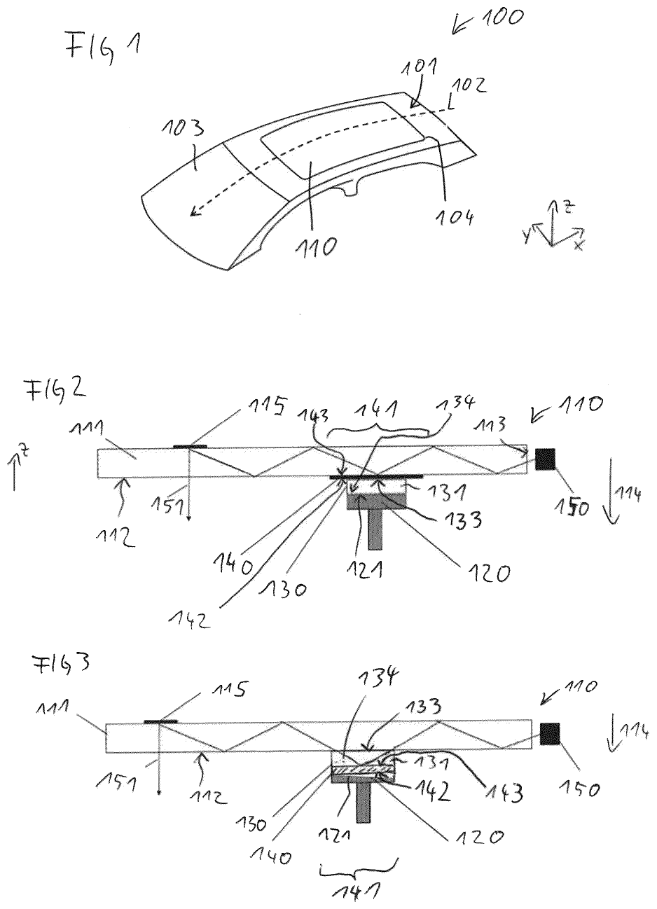

FIG. 1 shows a schematic representation of a vehicle 100. The vehicle 100 is in particular a passenger vehicle. The vehicle 100 comprises a plurality of glass panes, in particular a windshield 103 and a glass pane arrangement 110, which is provided as a roof window in a roof opening 104 of a vehicle roof 101 of the vehicle 100. A vehicle longitudinal direction 102 extends from a rear window in the direction toward the windshield 103.

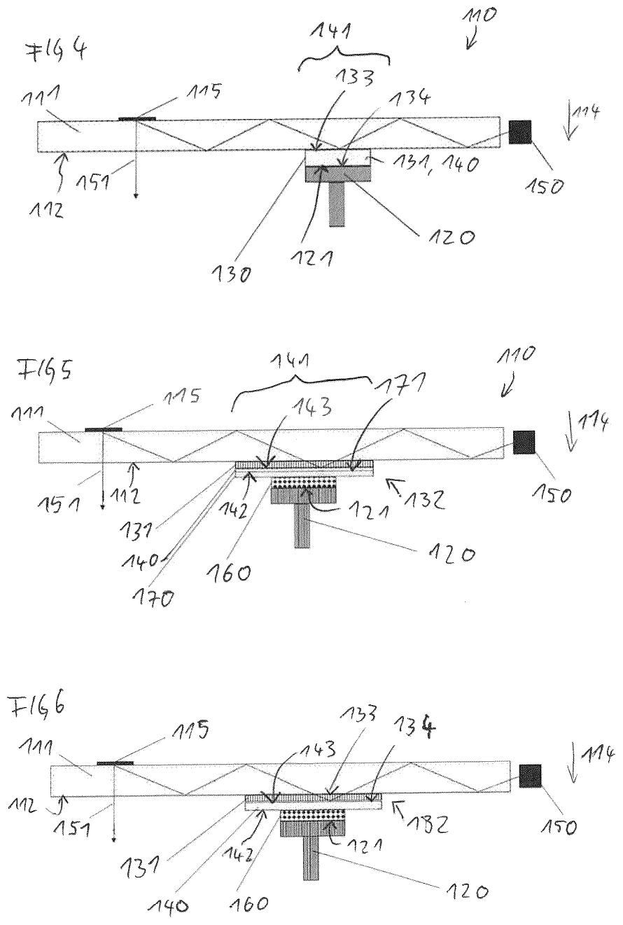

FIG. 2 shows the glass pane arrangement 110 according to an exemplary embodiment. The glass pane arrangement 110 comprises, for example, further glass panes which are not explicitly shown. For example, a light-guiding glass pane 111 of the glass pane arrangement 110 faces toward an interior of the vehicle 100. The light-guiding glass pane 111 is flatly extended and extends in particular with a main side 112 along an XY plane (FIG. 1). The main side 112 faces toward the interior of the vehicle in operation. The main side 112 has a significantly greater extension than a transverse side 113 oriented transversely thereto. In operation, the main side 112 is oriented in particular essentially along the horizontal. The transverse side 113 is oriented essentially along the, or parallel to, the normal to the main side 112, i.e. essentially along the vertical, thus in particular along a vertical direction Z.

A light source 150 is provided to couple light 151 into the light-guiding glass pane 111 at the transverse side 113. The light source 150 in particular comprises one or more LEDs or other light-emitting elements. Alternatively or additionally, light 151 can also be coupled in via coupling elements (not explicitly shown), for example a prism, a diffuser element, light guides via the main side or via a side opposite to the main side. Alternatively or additionally, coupling points can be formed in the light-guiding glass pane 111, for example as depressions in the main side 112.

The light 151 is guided in the light-guiding glass pane along the main side 121, since a total reflection takes place at the boundary surfaces of the light-guiding glass pane, for example at the transition between the main side of the light-guiding glass pane 111 and air. The light 151 can therefore also be distributed over the plate-shaped extension of the light-guiding glass pane 111. At predetermined locations at which the light 151 is to be decoupled, a decoupling structure 115 is provided. The decoupling structure 115 is, for example, an imprint, a superficial change, or another element and has the result that the light 151 leaves the light-guiding glass pane 111 at the main side 112.

The glass pane arrangement 110 comprises a functional element 120. The functional element 120 is in particular an attachment element. For example, an interior roof lining of the vehicle 100, which covers a body, is fastenable by means of the functional element 120 on the glass pane arrangement 110 in particular of the light-guiding glass pane 111. The functional element 120 can also have another function. For example, three functional elements 120 spaced apart from one another are fastened along the longitudinal direction X and/or along a transverse direction Y in relation to one another on the light-guiding glass pane 111. The functional element 120 has, for example, an area between 2 and 8 square Centimeters, in particular between 5 and 7 square centimeters. In particular, a coupling surface 121 of the functional element 120 has this extension.

The coupling surface 121 faces toward the light-guiding glass pane 111, in particular the main side 112. The functional element 120 is fastened on the light-guiding glass pane 111 by means of the coupling surface 121.

The glass pane arrangement 110 comprises an adhesive bond 130. The adhesive bond 130 is used to attach the functional element 120 to the light-guiding glass pane 111. The adhesive bond 130 is arranged along the vertical direction Z between the coupling surface 121 and the main side 112. The functional element 120 is therefore adhesively bonded to the light-guiding glass pane 111. The adhesive bond 130 is formed, for example, as an adhesive layer 131 made of an adhesive. Alternatively, the adhesive bond 130 can comprise an adhesive layer 131 on the side facing toward the main side 112 and a further adhesive layer on the side facing toward the functional element 120. The adhesive bond 130 can be constructed from multiple adhesive layers.

The glass pane arrangement 110 comprises a reflection layer 140. In the exemplary embodiment according to FIG. 2, the reflection layer 140 is arranged between the main side 112 and the adhesive layer 131. The adhesive layer 131 comprises an adhesive surface 133, which is in preferably direct contact with a first surface 142 of the reflection layer 140. The reflection layer 140 is formed planar. The first surface 142 is a surface of the reflection layer 140 which faces away from the light-guiding glass pane 111.

The reflection layer 140 comprises a second surface 143, which is in contact with the main side 112 of the light-guiding glass pane 111.

The reflection layer 140 is arranged on the main side 112 of the light-guiding glass pane 111 along a stacking direction 114, which is oriented along the vertical direction Z. The adhesive layer 131 of the adhesive bond 130 is arranged on the first surface 142 of the reflection layer 140. The functional element 120 is arranged on a further adhesive surface 134 of the adhesive bond 130, which faces away from the light-guiding glass pane 111. The adhesive surface 134 is in particular part of the adhesive layer 131.

The reflection layer 140 is designed to reflect the light 151 in an area 141 of the functional element 120. In particular, the light 151 is reflected at the reflection layer 140 without the light 151 being able to enter the adhesive layer 131 and/or without the light 151 being able to reach up to the functional element 120, in particular up to the coupling surface 121. Undesired decoupling and/or absorbing of the light 151 is therefore avoided in the area 141. An undesired spectral shift is also prevented in the area 141. The light 151 is also reliably held in the light-guiding glass pane 111 in the area 141, even if no transition is present between light-guiding glass pane 111 and air or another medium (for example, a connecting film), which has, for example, a lower index of refraction in comparison to the light-guiding glass pane 111.

In the illustrated exemplary embodiment, the reflection layer 140 comprises, for example, a metal layer. For example, the reflection layer 140 comprises an aluminum layer which is made mirrored. The reflection layer 140 is, for example, vapor deposited and/or printed on the main side 112. In the present exemplary embodiment, a majority of the main side 112, thus in particular more than 90% of the main side 112, is free of the reflection layer 140. The reflection layer 140 is preferably only applied where the functional element 120 is to be arranged on the light-guiding glass pane 111.

The reflection layer 140 thus enables light guiding of the light 151 along the light-guiding glass pane 111 and local attenuation due to absorption or undesired decoupling is avoidable. The light 151 appears to be homogeneously distributed or guided to a human observer, without a significant spectral division and/or a significant intensity loss occurring in the area of the coupled-on functional element. The reflection layer 140 is mirrored and therefore opaque to the light 151. In the area 141, the light 151 therefore remains in the light-guiding glass pane 111. Luminance losses are therefore significantly reduced.

FIG. 3 shows the glass pane arrangement 110 according to a further exemplary embodiment. In contrast to the exemplary embodiment according to FIG. 2, the reflection layer 140 is arranged between the coupling surface 121 of the functional element 120 and the further adhesive surface 134 of the adhesive bond 130.

The adhesive layer 131 is therefore arranged on the main side 112 of the light-guiding glass pane 111 along the stacking direction 114. The reflection layer 140 is arranged on the further adhesive surface 134 of the adhesive bond 130. The functional element 120 is arranged on the first surface 142 of the reflection layer 140. The coupling surface 121 of the functional element 120 is in direct contact with the reflection layer 140.

In the area 141, the light 151 can enter the adhesive layer 131 or the adhesive bond 130 due to minor differences of the indices of refraction of the light-guiding glass pane 111 and the adhesive layer 131. At the second surface 143 of the reflection layer 140 facing toward the light-guiding glass pane 111, the light 151 is reflected back in the direction of the light-guiding glass pane 111 and couples back into the light-guiding glass pane 111. The light 151 is reflected at the reflection layer 140 without the light 151 being able to reach the functional element 120. Absorptions, in particular an intensity loss and/or a spectral division of the light 151 at the functional element 120, are therefore avoided. Luminance losses can therefore be significantly reduced.

The reflection layer 140 is, for example, a metallic or other type of mirroring on the coupling surface 121. For example, the coupling surface 121 is mirrored using an aluminum layer or silver.

FIG. 4 shows the glass pane arrangement 110 according to a further exemplary embodiment. The reflection layer 140 is implemented by means of the adhesive layer 131 or the adhesive bond 130. For this purpose, the adhesive layer 131 or the adhesive of the adhesive layer 131 or the adhesive bond 130 has an index of refraction which differs from the index of refraction of the light-guiding glass pane 111 or which is matched to the index of refraction of the light-guiding glass pane glass pane 111 in order to cause a reflection at the common boundary surface. An index of refraction jump is therefore also implemented in the area 141, which results in a total reflection of the light 151. Therefore, due to the index of refraction differences, the light reflection also takes place in that area 141, in which the adhesive bond 130 is formed, similarly as outside the area 141 at the transition between the light-guiding glass pane 111 and air. For example, the adhesive layer 131 has an index of refraction of less than 1.45, in particular an index of refraction of less than 1.35. A separate reflection layer 140, which is formed in addition to the adhesive layer 131, can therefore be omitted. The reflection of the light 151 takes place directly at the transition between the light-guiding glass pane 111 and the adhesive layer 131, thus in particular at the transition between the main side 112 and the adhesive surface 133. The light 151 therefore does not penetrate or only penetrates to an extremely reduced extent into the adhesive layer 131. Luminance losses can therefore be significantly reduced.

Therefore, along the stacking direction 114, first the light-guiding glass pane 111 is provided and the adhesive layer 131 on the main side 112. The functional element 120 is arranged on the further adhesive surface 134. The coupling surface 121 of the functional element 120 is in direct contact with the adhesive layer 131, which also forms the reflection layer 140. The adhesive layer 131 and the further adhesive surface 134 can also be integrally formed here and thus form a single surface.

FIG. 5 shows the glass pane arrangement 110 according to a further exemplary embodiment. The functional element 120 is fastened by means of an adhesive tape 132 on the light-guiding glass pane 111. The adhesive tape 132 comprises a substrate 170. The substrate 170 is flexible, for example. The substrate 170 is formed from a plastic, for example. The substrate 170 comprises PET, for example.

The reflection layer 140 is arranged between the substrate 170 and the light-guiding glass pane 111. The substrate 170 comprises a substrate surface 171 facing toward the light-guiding glass pane 111. The reflection layer 140 is arranged on the substrate surface 171.

The reflection layer 140 is formed in particular as a mirror layer, for example as a layer comprising metal and/or as a layer having low index of refraction.

The adhesive layer 131 is arranged on the second surface 143 of the reflection layer 140, which faces toward the light-guiding glass pane 111.

Therefore, the light-guiding glass pane 111, then the adhesive layer 131, then the reflection layer 140, and then the substrate 170 are arranged along the stacking direction 114.

The functional element 120 is connected by means of a further adhesive bond 160 to the substrate 170. The further adhesive bond 160 comprises an adhesive which is applied, for example, to the coupling surface 121 in order to fasten the functional element 120 on the adhesive tape 132. It is also possible that the adhesive tape 132 comprises the further adhesive bond 160 and/or is formed, for example, as a double-sided adhesive tape. Therefore, both the adhesive layer 131 and the adhesive layer of the further adhesive bond 160 is connected to the substrate 170. The functional element 120 can then be connected by means of the double-sided adhesive tape 132 to the light-guiding glass pane 111.

In operation, the light 151 can enter the adhesive layer 131 in the area 141. The light is reflected back into the light-guiding glass pane 111 by means of the reflection layer 140. The light 141 does not reach up to the substrate 170, the further adhesive bond 160, and/or the functional element 120. Luminance losses are therefore significantly reduced.

FIG. 6 shows the glass pane arrangement 110 according to a further exemplary embodiment. The functional element 120 is fixed by means of the adhesive tape 132 on the light-guiding glass pane 111. In contrast to the exemplary embodiment according to FIG. 5, however, the adhesive tape 132 does not have a separate substrate 170. The adhesive tape 132 is formed by means of the reflection layer 140 and the adhesive layer 131. If the adhesive tape 132 is formed as a double-sided adhesive tape, the further adhesive layer of the further adhesive bond 160 is moreover provided. The reflection layer 140 therefore takes over the substrate function, for example.

Therefore, along the stacking direction 114, the adhesive layer 131 and directly then the reflection layer 140 is provided on the light-guiding glass pane 111. The second surface 143 of the reflection layer 140 is in direct contact with the further adhesive surface 134 of the adhesive layer 131. The further adhesive bond 160 is formed on the first surface 142 of the reflection layer 140. The functional element 120 is arranged on the further adhesive bond 160.

In operation, light passes through the adhesive layer 131 up to the reflection layer 140 and is reflected there back to the light-guiding glass pane 111. The light 151 therefore does not reach the further adhesive bond 160 and in particular does not reach the functional element 120. Luminance losses can therefore be significantly reduced.

The glass pane arrangement 110 having the reflection layer 140 according to the different exemplary embodiments also enables the reduction of the luminance loss in the area 141 in which the adhesive bond 130 is formed. Undesired decoupling of the light 151 and/or absorption of the light 151 at the dark functional element 120 is avoidable by means of the reflection layer 140. Color changes at colored surfaces are avoidable. The local adhesive bonds for fixing the functional elements 120 are therefore implementable in the areas 141 without this resulting in an inhomogeneity of the light picture. The glass pane arrangement 110 therefore enables reliable interior illumination for the vehicle 100.

### REFERENCE SIGNS

100 vehicle
101 vehicle roof
102 vehicle longitudinal direction
103 windshield
104 roof opening
110 glass pane arrangement
111 light-guiding glass pane
112 main side
113 transverse side
114 stacking direction
115 decoupling structure
120 functional element
121 coupling surface
130 adhesive bond
131 adhesive layer
132 adhesive tape
133 adhesive surface
134 further adhesive surface
140 reflection layer
141 area
142 first surface
143 second surface
150 light source
151 light
160 further adhesive bond
170 substrate
171 substrate surface
X longitudinal direction
Y transverse direction
Z vertical direction

1. A glass pane arrangement for a vehicle, comprising:
a plate-shaped light-guiding glass pane,
a functional element, which is fixed by an adhesive bond on a main side of the light-guiding glass pane,
a reflection layer, which is arranged between the light-guiding glass pane and the functional element to reflect light in the direction of the light-guiding glass pane.

2. The glass pane arrangement as claimed in claim 1, wherein the reflection layer is arranged between the light-guiding glass pane and the adhesive bond.

3. The glass pane arrangement as claimed in claim 1, wherein the reflection layer is applied to the main side of the light-guiding glass pane.

4. The glass pane arrangement as claimed claim 1, wherein the reflection layer is arranged between the functional element and the adhesive bond.

5. The glass pane arrangement as claimed in claim 1, wherein the reflection layer is applied to the functional element.

6. The glass pane arrangement as claimed in claim 1, wherein the adhesive bond comprises an adhesive layer and the reflection layer is formed by the adhesive layer.

7. The glass pane arrangement as claimed in claim 6, wherein the adhesive layer has a first index of refraction and the light-guiding glass pane has a second index of refraction, wherein the first index of refraction is less than the second index of refraction.

8. The glass pane arrangement as claimed in claim 1, wherein the adhesive bond comprises an adhesive tape and the reflection layer is part of the adhesive tape.

9. The glass pane arrangement as claimed in claim 1, further comprising a light source, which is designed to emit light, so that the light can be coupled into the light-guiding glass pane.

10. The glass pane arrangement as claimed in claim 9, wherein the light source is designed so that the light can be coupled in at the main side or at a side opposite to the main side.

11. A vehicle having a roof opening, comprising a glass pane arrangement as claimed in claim 1, wherein the glass pane arrangement closes the roof opening.
